(19) United States
(12) Patent Application Publication
(10) Pub. No.: US 2006/0033737 A1
(43) Pub. Date: Feb. 16, 2006

(54) Methods and system for visualizing data sets

(76) Inventors: William M. Old, Boulder, CO (US); Dean R. Thompson, Fort Collins, CO (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/919,962

(22) Filed: Aug. 16, 2004

(51) Int. Cl. G06T 11/20

(52) U.S. Cl. 345/440

(57) ABSTRACT

Methods, systems and recordable media for viewing large data sets having extremely disproportional dimensions on a symmetrical display. Data sets in matrix form having many more rows than columns or vice versa may be manipulated to make maximum use of a symmetrical display. Further data management processes facilitate navigation through large datasets and provide the ability to look at one or more portions of the data set in detail while still maintaining the context of the entire data set, or a larger portion of the dataset.

### FIELD OF THE INVENTION

The present invention pertains to the field of data management. More particularly, the present invention relates to manipulation of large datasets having disproportional dimensions, for more efficient viewing and navigation of the data.

### BACKGROUND OF THE INVENTION

Visualization of large scale datasets may be currently managed by scaling the data to fit on a single display. Such scaling may require compression, or even if no compression is used, the data is often reduced to a scale that is unreadable in the single image display. However, select regions of such a display may be panned to and/or zoomed in to make the data readable. This may provide a sense of the total context of the data, from the overall single display image of all the data, as well as some level of detail of a select portion or portions of the data. These approaches work fairly well for datasets that are more or less “square”, i.e., where the number of columns of the data is roughly equal to the number of rows of the data.

However, when the number of rows and columns of data become significantly unequal or disproportionate, scaling of such datasets to fit on a single display gives results which are very difficult to work with, since scaling to reduce the larger number (of rows or columns, as it may be) overscales the smaller number (of rows or columns, respectively) to make the smaller dimensional virtually undetectable and unusable, since the overscaling often makes the smaller dimension virtually invisible with regard to individual cells of the rows (or columns) and even makes trends undetectable in many cases.

Thus, there is a need to provide improved methods and systems for providing a single display of very large datasets which are asymmetrical (e.g., number of rows is much greater than number of columns, or number of columns is much greater than number of rows).

### SUMMARY OF THE INVENTION

Methods, systems and recordable media are provided for manipulating large datasets for display, and displaying them. The present invention is particularly useful for datasets wherein a first dimension of the data to be displayed is much larger than a second dimension of the data to be displayed causing the dataset to be disproportional to a display on which the dataset is to be viewed. The dataset is subdivided along the first dimension to form segments of the dataset, each segment having a fraction of the first dimension and all of the second dimension. At least a subset of the segments formed are displayed adjacent one another on the display, thereby using the area of the display more efficiently.

All segments generated from the dataset may be displayed on the display at the same time.

Subdivision of a dataset may be performed automatically by the system, based on the first and second dimensions and dimensions of the display on which the dataset is to be viewed, or may be performed based at least partially on user input, such as an input directing the number of segments to be formed, or input directing or changing the size of one or more segments.

The segments may be formed to have approximately equal dimensions.

Further provided is the ability of a user to select a location on one of the displayed segments, after which the system calculates and displays a line through the center of the location and parallel to the first dimension to establish a reference line relative to the second dimension. At the same time, the system calculates and displays a line on each of the remaining displayed segments, parallel to the first dimension and at the same location relative to the second dimension established with the generation of the line through the center of the selected location. This process may be repeated with a different location to change the locations of the reference lines. Alternatively, the user may choose to leave the original reference lines in place and still make another location selection, wherein the system displays another set of reference lines. This may be done with multiple locations. When displaying more than one set of reference lines, the differing sets may be color coded to aid in distinguishing between the different sets.

Alternatively, or in addition thereto, the system may provide means for user input of a reference to a location where the user wants the reference line to be displayed. Based upon this input, the system calculates and displays a line through the location identified by the user's input and parallel to the first dimension to establish a reference line relative to the second dimension at the inputted location. Reference lines are displayed on all of the displayed segments in the same respective locations.

Reference lines may be dragged and dropped by the user to change the location thereof relative to the second dimension. When a user drags and drops a reference line, the remaining reference lines corresponding to the reference line having been dragged and dropped are automatically repositioned to the same respective location relative to the second dimension, in the other segments.

The system further comprises means for zooming such that a user may select an area within one of the displayed segments to be zoomed, and, in response to the selection, the system zooms the selected area to be zoomed, in the second dimension, so that only the selected portion of the segment in the second dimension is displayed while the entire first dimension of the segment is displayed. At the same time, corresponding areas of the remaining displayed segment are zoomed similarly in the second dimension, so that only the dimension of the corresponding area in each segment is displayed while the entire first dimension of each segment is displayed.

Optionally, only a subset of the total number of segments formed may be displayed on the screen at any one time. In this case, the system provides means for scrolling from one screen of displayed segments to another. Additionally, the means for scrolling may include a scale to provide the user with context as to where in the dataset the data shown in the present display is being viewed from.

The system further provides for user selection of less than all of the segments that are displayed, and zooming the selected segments to maximize use of the display, by displaying only the zoomed, selected segments. A variation for optimizing display of the selected segments includes subdividing the selected segments and then zooming them to maximize the display of the subdivided, selected segments.

The present invention also includes forwarding a result obtained from any of the methods described herein, transmitting data representing a result obtained from any of the methods described herein, and receiving a result obtained from any of the methods described herein.

These and other advantages and features of the invention will become apparent to those persons skilled in the art upon reading the details of the methods and systems as more fully described below.

### BRIEF DESCRIPTION OF THE DRAWINGS

FIG. 1 shows a partial display of an LCMS (Liquid Chromatography/Mass Spectrometry) three-dimensional dataset 100 from an electrospray ionization time of flight (ESI-TOF) analysis of a five-protein mixture.

FIG. 2A shows a schematic representation where the number of rows of a dataset are disproportionately greater than the number of columns in the dataset.

FIG. 2B shows subdivision of the dataset of FIG. 2A into segments.

FIG. 2C shows display of the segments formed in FIG. 2B on a single display.

FIG. 2D shows the display of a reference line on each of the segments displayed in FIG. 2C.

FIG. 2E shows the generation and display of a reference line on each of the segments displayed, based on user input of a reference value indicating where the reference lines are to be generated.

FIG. 2F shows a display generated based upon user selection of scan range and number of subdivisions to be displayed.

FIG. 2G shows the selection of a location within a segment to be zoomed.

FIG. 2H shows the resultant zooming based on the selection in FIG. 2G.

FIG. 3A shows a dataset having been subdivided into a number of segments selected by a user.

FIG. 3B shows a display of the segments generated in FIG. 3A.

FIG. 3C shows a zoomed view of three of the nine segments from FIG. 3B, which were selected by the user for zooming.

FIG. 4 shows an example where only a subset of the total number of segments is displayed at any one time, and where the system provides means for scrolling from one display to the next.

FIG. 5 shows a display of the entire dataset from which only of portion of the same is shown in FIG. 1.

FIG. 6 illustrates a typical computer system that may be employed in accordance with the present invention.

### DETAILED DESCRIPTION OF THE INVENTION

Before the present systems and methods are described, it is to be understood that this invention is not limited to particular data, software, hardware or method steps described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a row” includes a plurality of such rows and reference to “the bar” includes reference to one or more bars and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

In the present application, unless a contrary intention appears, the following terms refer to the indicated characteristics.

When one item is indicated as being “remote” from another, this is referenced that the two items are at least in different buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

The display of large sets of data for viewing and interpretation by a user is a challenging endeavor, in that not only should as much or all of the data be presented to the user in a single view so that the user has a sense of context in which the date resides, with regard to any particular data that the viewer is studying at any one time, but at the same time, the data needs to be easily readable and interpretable. The conflicting requirements to meet both of these presentation goals are further complicated when the shape of the dataset to be viewed does not conform to the shape of the display on which the dataset to be displayed. Some common examples of this are: use of a computer display which is square or nearly square to display a dataset that is rectangular and extremely disproportional to the computer display, such as a matrix of data having many more columns than rows, or a matrix of data having many more rows than columns. Data sets to be displayed may be represented in two- or greater dimensions.

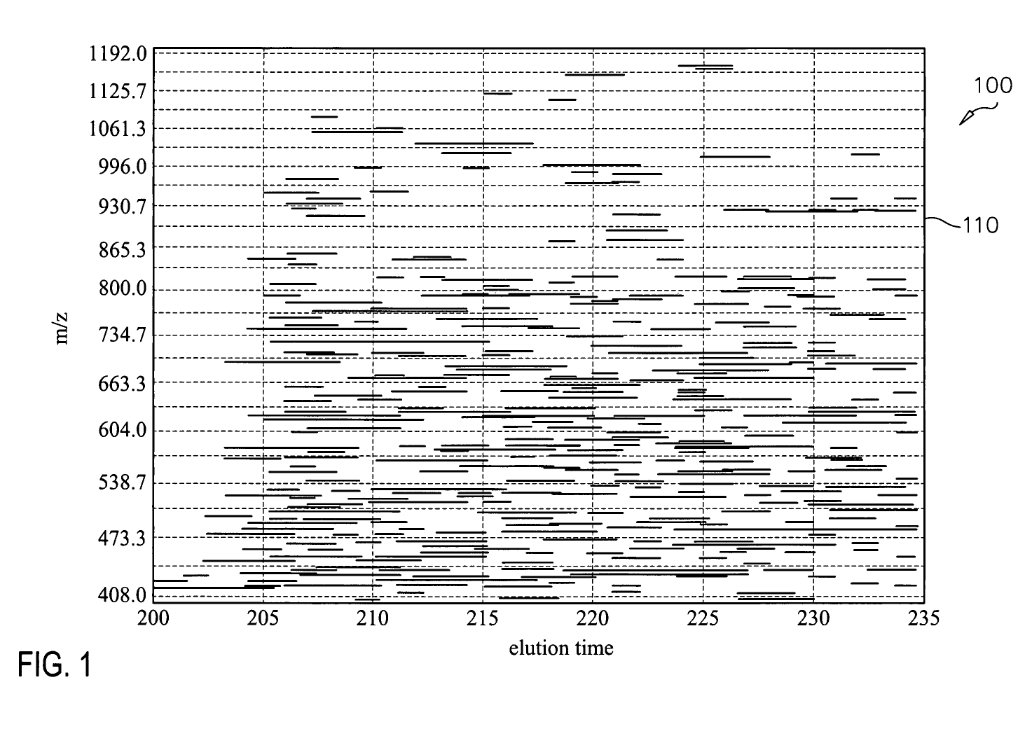

For example, FIG. 1 shows a partial display of an LCMS three-dimensional dataset 100 from an electrospray ionization time of flight (ESI-TOF) analysis of a five-protein mixture. Dataset 100 includes a series of spectra acquired at increasing elution times, which result in a matrix of intensity values with column and row positions corresponding to specific elution time (column position) and m/z value (row position), and intensity, which is the third dimension, that is often represented by color variation of the data points to represent variation in the intensity values. The “m/z value” is a measurement of ion mass as detected by a mass spectrometer. The “m/z value” actually corresponds to (m+z)/z, where m is the mass of the ion in Daltons (Da) and z is the charge state of the ion. The m/z value is properly measured in Thompsons, but m/z is a unitless ratio that is commonly used. Thus, for example, an ion with a charge of +2 and a mass of 198 Da gives an “m/z value” of 100 (i.e., (198+2)/2). In this example, dataset 100 has 550 columns (i.e., scans or spectra at varying elution times) and 20,000 rows (i.e., m/z values).

When such a dataset 100 is displayed with an aspect ratio approximately equal to 1, such as is shown in FIG. 1, for example, and is configured to show all rows as well as all columns, the detail in the “y dimension” (i.e., axis along which m/z values are displayed) is difficult, if not impossible to discern. In instances where data is sparse, such compression tends to completely eliminate data often times, or render it invisible when there are not clusters of data located closely enough to generate a pixel representation of the data. However, if the data is not compressed, or scaled down to fit the entire y dimension of the data on the screen, but is displayed so that the x axis is of size sufficient to read the rows, there would be many screens of data that would need to be scrolled through in order to observe all the data, and comparisons between screens of data is very difficult, since they cannot be observed simultaneously.

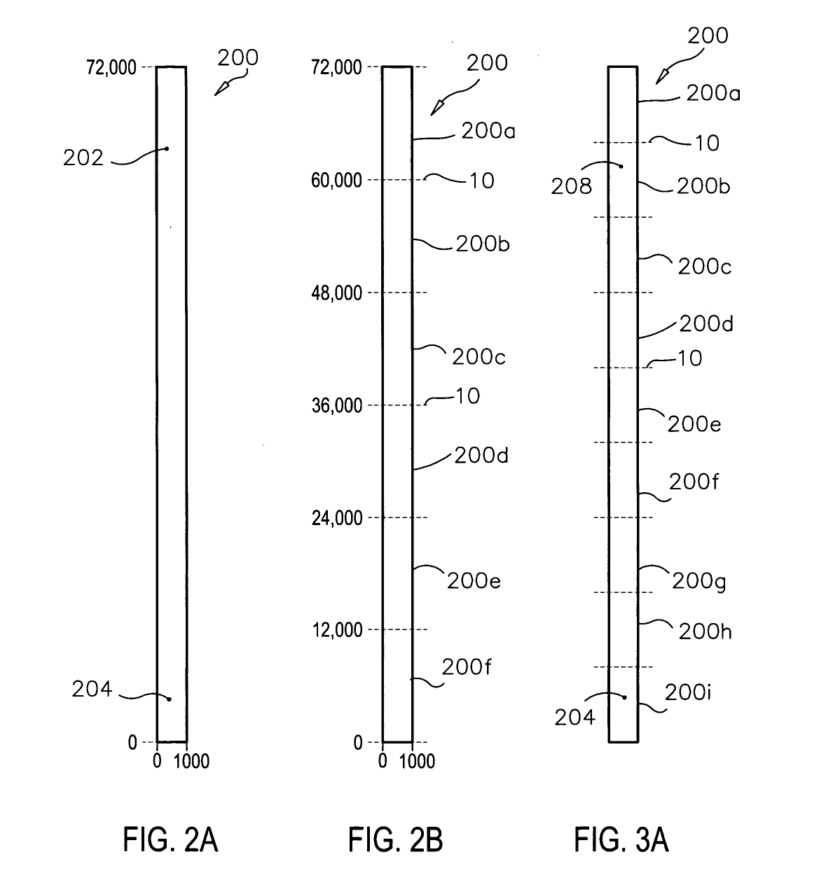

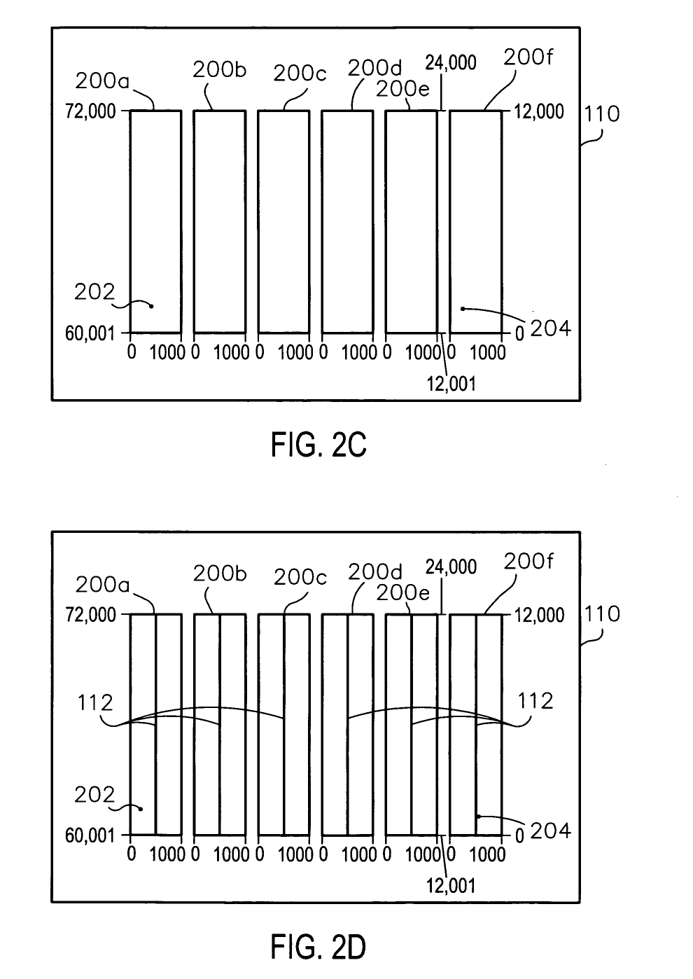

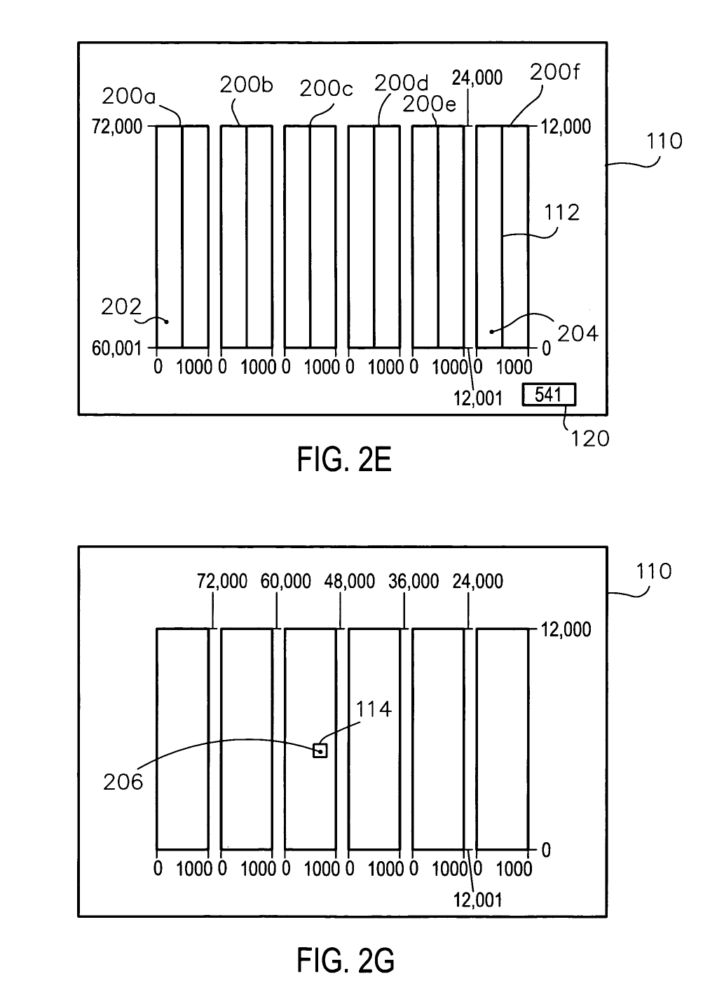

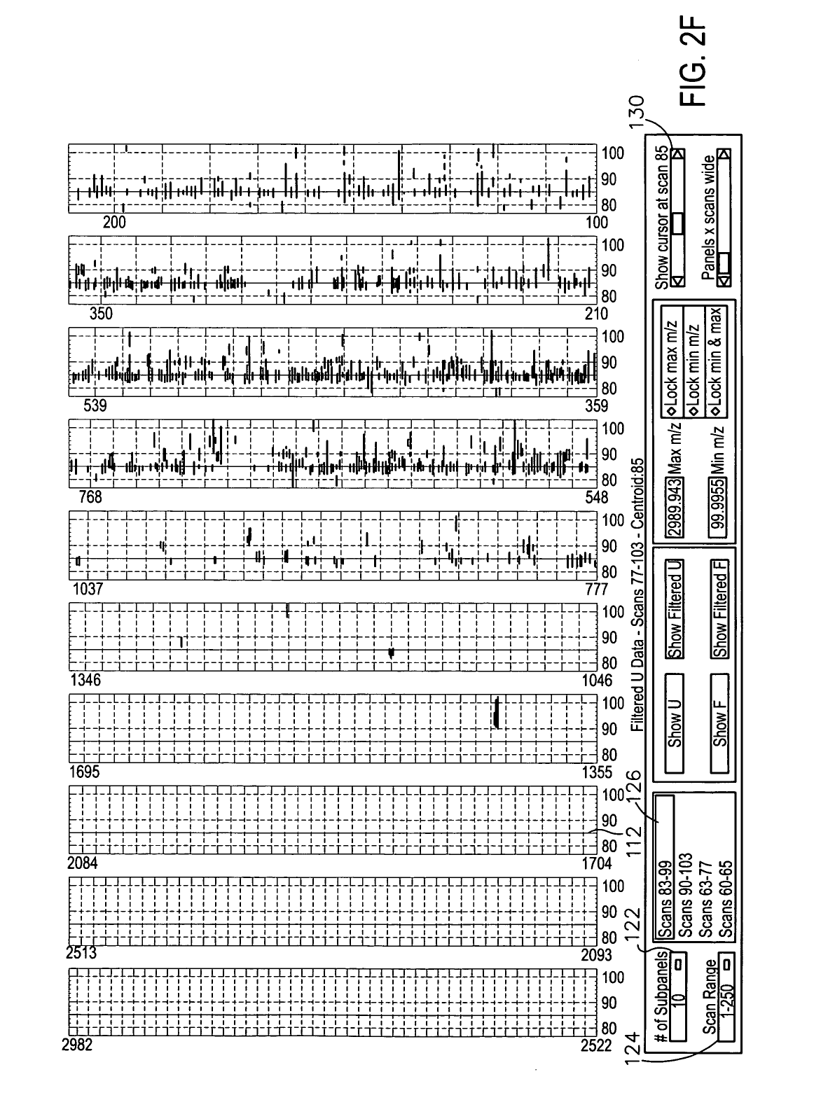

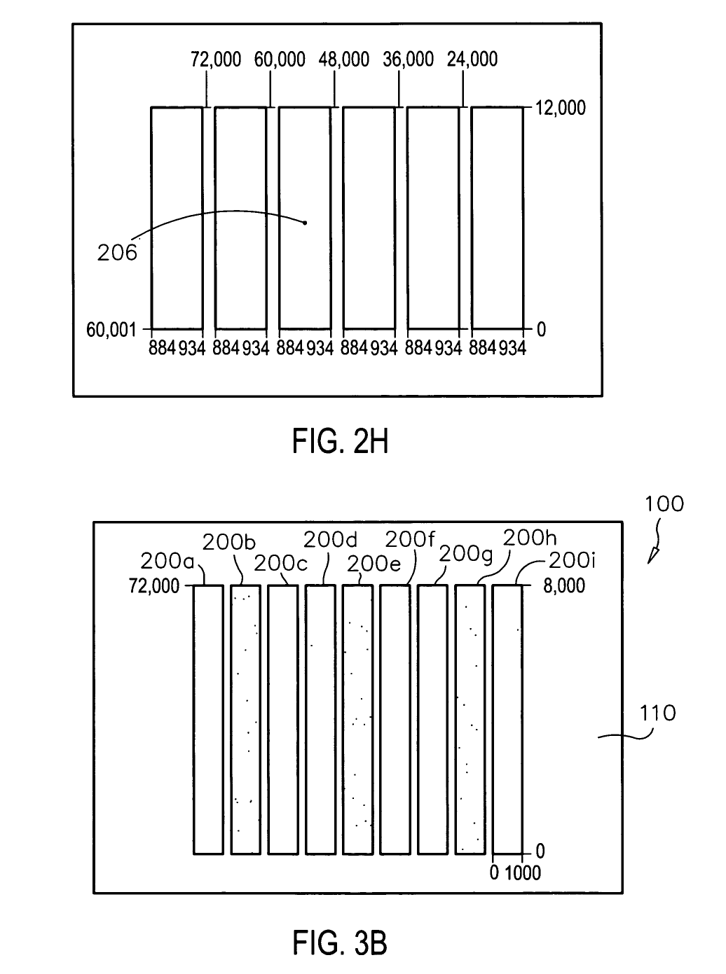

The present invention provides systems and methods for breaking up disproportionate datasets, such as dataset 100 described above for example, and breaking up the larger dimension of the dataset into segments to be displayed together on a display. A disproportionate data set has one dimension that is substantially larger than the other dimension. For example, a disproportionate data set may have one dimension (e.g., number of rows) that is twenty five or more times the other dimension (e.g. number of columns). For example, FIG. 2A shows a schematic representation where the number of rows of dataset 200 are disproportionately greater than the number of columns in the dataset, similar to that discussed above with regard to dataset 100. For example, there may be one thousand scans (number of columns) across the x-direction of the dataset 200 and 70,000 to 100,000 data points (rows) in the y-direction To view such a matrix 200 on a single screen or display in a proportional manner, the x-axis becomes so small as to be impractical to use. Additionally, the dataset 200 may be three dimensional data and displayed as a color map or grayscale map, for example, wherein variations in color or grayscale in the data points represent a third dimension, such as a measure of intensity, for example. Not only is viewing of the individual columns difficult in this example of a display, but it becomes even more difficult to correlate different data points as to their positions in the columns (e.g., on the time scale). Thus, it may be impossible for the viewer to determine whether data point 202 is in the same column as data point 204, for example. Even more likely, is that the data points disappear completely in such a view, particularly when the data is sparse, since it takes a consecutive number of rows or columns of data points to even register the display of a pixel on the display.

Rather than trying to display the entire dataset in the configuration shown in FIG. 2A, one approach of the present invention is to subdivide dataset 200 into subsets of rows, such as shown by the subdivision lines 10, for example in FIG. 2B. Although as shown, the subdivision are made so as to produce approximately or exactly equal subsets of the dataset, this is not a requirement of the invention. However, it may make the most sense, in terms of the geometry or real estate provided by the display on which the data is to be displayed, to subdivide the dataset into equal segments. It is further noted here, that although these particular examples relate to making vertical segments from a dataset that has a disproportionately large vertical dimension, that the subdivision to make horizontal segments from a dataset having a disproportionately large horizontal dimension may be performed similarly. This also applies to the other methods, techniques and features described herein, i.e., they apply equally well in either dimension.

The subdivisions 200a,200b,200c,200d,200e,200f of dataset 200 can then be displayed, side-by-side (horizontally stacked) on a single display screen 110 as shown in FIG. 2C. Because the geometry of the display 110 is now being used in a more efficient manner, subdivisions 200a-200f may be displayed in a zoomed or expanded view as shown in FIG. 2C, compared with the dimensions of the subdivisions 200a-200f as shown in FIG. 2B, thus affording the viewer easier viewing and better resolution of the data. Thus, the entire dataset 200 can be viewed simultaneously and at a greater degree of magnification.

Even with this display format, it may be problematic to try and correlate data points from different subsets as to how they compare relative to column positions. To address this problem the present system allows the user to select a data point of interest, and upon such selection, the system calculates the centroid of the selected location. A vertical line (or horizontal line in the case where the number of columns greatly exceeds the number of rows) 112 is drawn through the centroid and parallel to the “y” axis (or x-axis in a case where number of columns greatly exceeds number of rows) as shown in FIG. 2D. Line 112 is generated through all displayed segments 200a-200f, in the same position relative to the x-axis (or y-axis depending upon the asymmetry of the dataset) to act as a guide or maker for comparing data points across subsets. In the example shown in FIG. 2D, it can be seen that data point 202 is not in the exact same column as data point 204 but is in a column that is quite close to the column that data point 204 is located in. Line 112 may be repeatedly generated on successive data points, each time removing the previous line and generating a new line 112 based on the centroid of the next selected data point. Alternatively, the user may select to maintain more than one reference lines 112 at the same time on the display. Upon choosing this option, each new line that is generated will be generated with a different color-coding to make it easier to distinguish between reference points.

Alternatively, or additionally, the system may provide a text box 120 or other tool allowing user input for inputting where to display reference line(s) 112. In the example shown in FIG. 2E, the user has inputted column 541 as the location along which line 112 is generated. The input value does not need to be limited to column numbers, but may be values that are represented along the axis that line 112 is drawn perpendicular to. For example, an alternative arrangement of what is shown in FIG. 2E would request that the user input a time value (elution time) which the system would use as a basis for generation and display of line 112. Thus if a user is interested in studying results at a particular time (or other specific x-axis or y-axis characteristic) that the user has some interest in, perhaps after gaining knowledge from some other experiment or data source, then the user can directly go to the areas of interest using the text box input method.

As another alternative, FIG. 2F shows features that allow the user to select the number of subdivisions or subpanels 200 to be displayed through input box 122, and to select a subset of the entire dataset from which to analyze through input box 124. In the example shown, the total number of scans in the dataset was one thousand, and the user has selected to analyze scans one through two hundred fifty for purposes of the current analysis. Additionally, the user has selected to show ten subdivisions (subpanels) of the displayed data. Further, the user has chosen a “group of peaks” to display, by selecting a subset of the scan range selected through input box 124. The group of peaks selection in the example shown is selected as “Scans 83-89” through input box 126. Based upon these inputs, the system determines how many scans to show and calculates a centroid of the group of peaks. In this example, the system determined to shown scans 77 through 103 (to avoid presentation of the selected scan 83 and 89 on the boundaries of the display) and calculated the centroid (average peak intensity) to be on scan 85. The system then further plots centroid line 112 through scan 85, as shown in FIG. 2F, and automatically sets the cursor of scroll bar 130 at scan 85.

Still further, the system may provide for dragging and dropping line 112 once it is displayed, and text box 120 may display a value designating the location of wherever line 112 is dropped.

The system also provides for zoomed views to observe the data in greater detail about a user specified location. For example, a user may be interested in phenomena occurring in and about the vicinity of the occurrence of data point 206 (FIG. 2G) and wish to examine the data points in greater detail, with better resolution and thus want to zoom the view to areas surrounding this data point. One nonlimiting way of carrying out the zooming function is to click on or about the area of interest (in this case data point 206) and drag the cursor to draw a rectangular box 114 about the area of interest to establish the degree of zooming to be performed. Another example is to use a “lasso feature” to surround the area of interest and then input through an input device, such as a keyboard, or selection from a menu with a mouse or other input device, the degree of magnification. Other methods of initiating the zoom may be alternatively used, as would be apparent to those of ordinary skill in the art after reading the present disclosure.

Once the area to be zoomed has been established and the zooming process has been initiated, each segment of the display is zoomed similarly, as shown in FIG. 2H. In this example, the zoomed view includes only fifty columns (or scans, in this example), whereas the segments in the view of FIG. 2G each include one thousand columns. Note also, that the scan occurs in only one dimension, as all of the rows in this example have been retained in the view displayed in FIG. 2G. Again, it is noted that for examples where the number of columns greatly exceeds the number of rows, then the zooming would be performed to reduce the number of rows, while still displaying all columns.

Another feature of the present system allows the user to determine how many segments to divide a data set into for display. Up until this time, the discussion has been to automatic partitioning by the system, such as was discussed with regard to FIG. 2B, for example. The system may automatically partition the data set, for example, by determining the number of pixels along the x-axis that are required to display a row, and adding the determined number to a predetermined number of pixels representative of overhead spacing per column of display. Scaling is then performed (which may be variable, depending upon the magnitude of the y-axis of the data set), and the total available x-axis resolution of the display is then divided by the resultant number. The integer portion of the division results may then be used as the number of columns to be displayed. Further, the user may optionally specify the number of pixels to be used for displaying a row, prior to processing the above-noted automatic calculations.

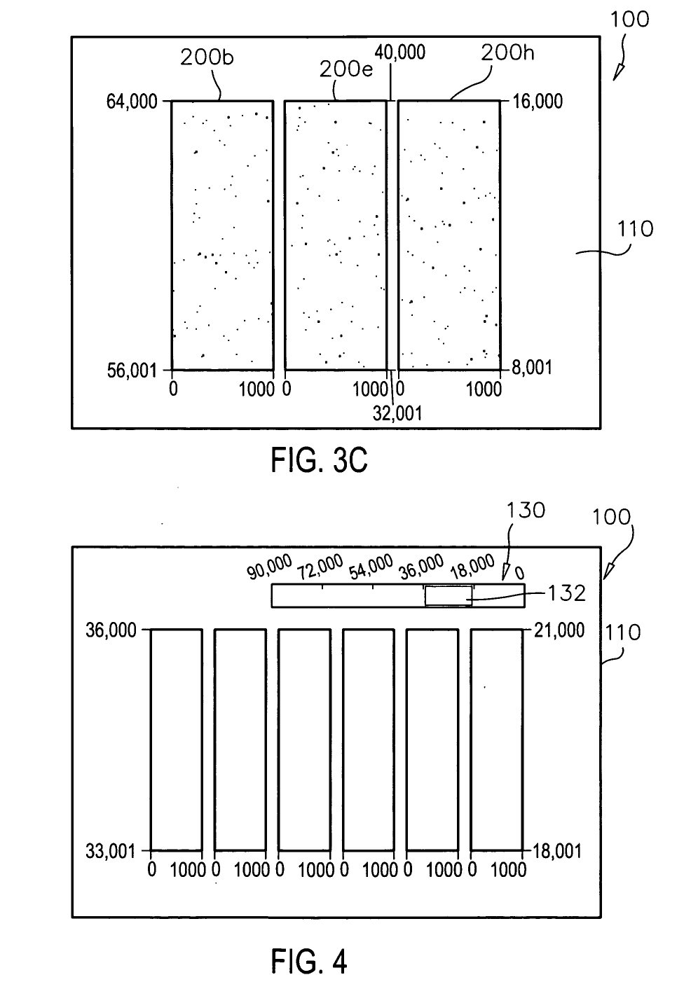

However, the user may optionally input the number of segments that he/she wants the data set to be divided into. This option may be made available through a text box, pull down menu or other function selection feature. In the example shown in FIG. 3A, the user has selected a division of the data set into nine segments 200a-200i. Although automatic, as well as user-selected subdivision of the data set defaults to subdivision to form equal segments of the data set, subdivision lines may be dragged and dropped, similar to the functionality of reference lines 112 discussed above, so that the user can form segments of unequal size if desired. This may be particularly useful where grouping or clustering of data occurs, such as in a particular segment of any one or more of segments 200a-200i.

A further aspect of the system allows the user to determine how many segments are displayed on display 110 at any one time. It may be advantageous to view the entire data set on a single display, and the system provides such viewing, as has been discussed up to this point. However, a user may decide to only view subsets of the entire dataset at any one time. For example, the user may divide data set into twenty segments and select to view only five segments per view on the display 110 at any one time. The five segments may be contiguous segments or may be individually selected by the user as a group to be viewed together. For example, in situations where the user finds data in the first, third, fourth, fifteenth and seventeenth segments, these segments may all be selected for display by the user.

As another example, and as an alternative to the zooming function already discussed, in FIG. 3B, the system has displayed all nine segments 200a-200i of data set 200 as divided in the manner discussed with regard to FIG. 3A. In this example, the user might find segments 200b, 200e and 200h interesting and think that they are worthy of a closer examination. By selecting on the segments of interest, the user may employ the system to display only those segments, and thus in a more magnified view, since the system expands the segments displayed to maximize use of the real estate (area of the display) upon which the segments are shown. This effectively increases the resolution in the x-axis, while maintaining the resolution of the y-axis and simply showing fewer columns. A representation of the resulting view from this selection is shown in FIG. 3C. Alternatively, the user may choose to subdivide the selected columns according to the total number of columns that were previously displayed, thereby increasing the y-axis resolution while maintaining the existing x-axis resolution.

Note that, like in the previous zooming operations, the zooming in this example is only in the direction of the x-axis. However, unlike the previous examples, all of the columns are still shown in each segment that continues to be displayed. The zooming ability is afforded by the fact that less segments are displayed on the screen at one time. It is further noted that all of the functionalities described earlier are retained in this zoomed view. For example, full functionality with one or more reference lines is still afforded. Also, the user may further zoom a portion of the segments at will.

Another option provided to the user by the system is the ability to display a subset of the total number of segments per screen where the user can scroll from screen to screen to view all of the segments. The segments in this instance may be either automatically divided and generated, or generated according to the desired user number of segments or other user input (such as by selecting where to divide the segments, for example). FIG. 4 show an example where a data set having 90,000 rows and one thousand columns of data has been subdivided into 30 segments. In the view of FIG. 4, six segments are displayed showing rows 18,001 to 36,000 consecutively. A scroll bar 130 may be provided to serve as an indicator of context to the user, e.g., to show where the user currently is, in navigating the data. A cursor 132 or other indicator may be provided to show which portion of the data is being displayed relative to the entire data set. The system may further automatically calculate the scale for the scroll bar, such as is shown in FIG. 4, where the system has calculated the scale to run from zero to 90,000 columns.

Scroll bar 130 provides further functionality in that the user may select on the indictor 132 and slide it either up or down (or to the left or right, depending upon the orientation of the scroll bar 130) to change the display 110 as to which segments are shown thereon. Zooming and reference capabilities, as described earlier are also available with this view.

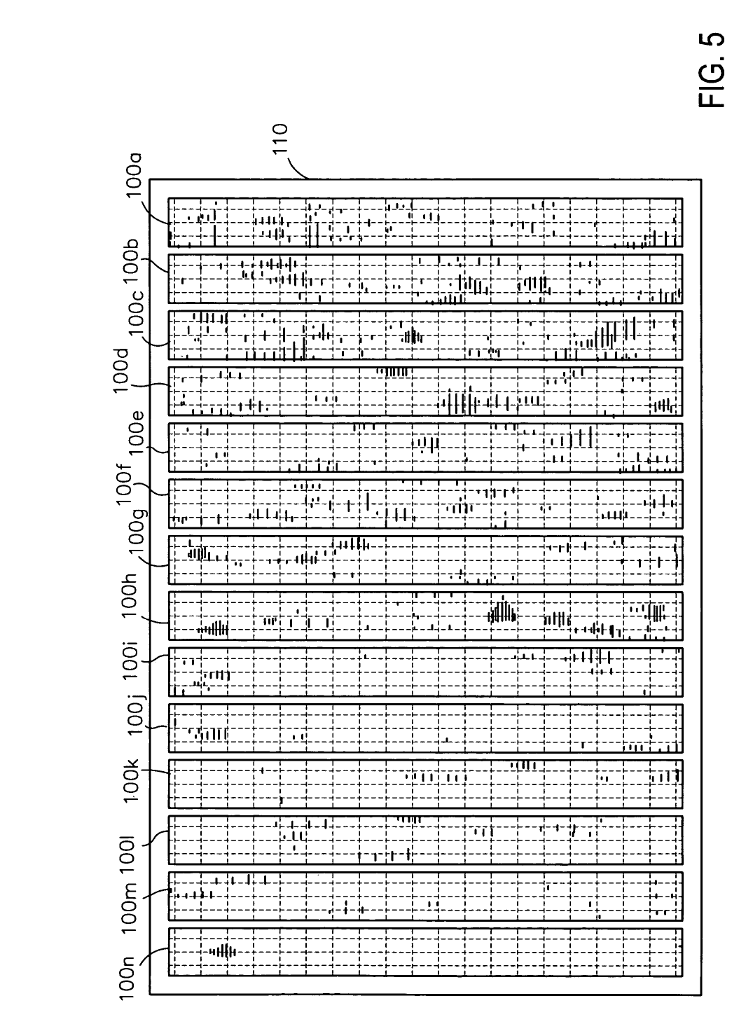

FIG. 5 shows a single screen display of data set 100 (from FIG. 1) which has been segmented by the system into fourteen segments 100a,100b,100c,100d,100e,100f,100g,100h,100i,100j,100k,100l,100m,100n according to the principles described above, so that the entire data set 100 may be viewed by a user on a single screen display 110.

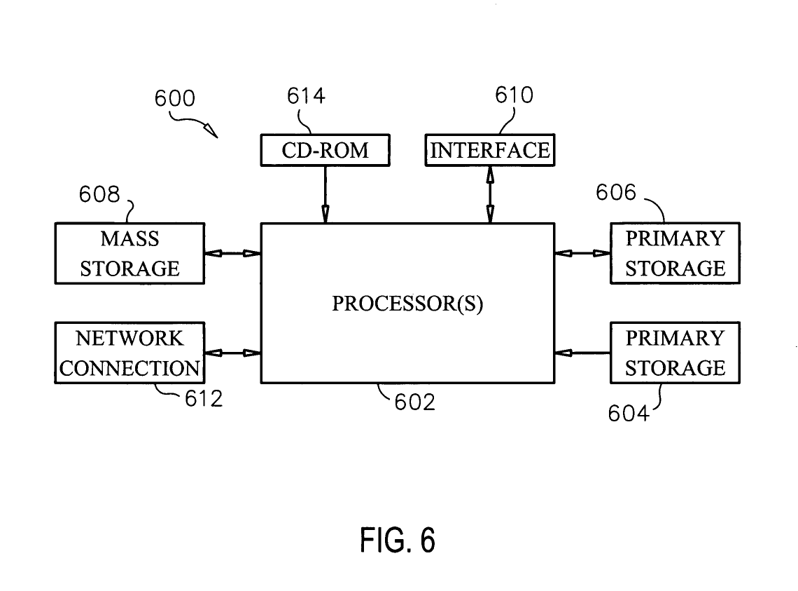

FIG. 6 illustrates a typical computer system in accordance with an embodiment of the present invention. The computer system 600 may include any number of processors 602 (also referred to as central processing units, or CPUs) that are coupled to storage devices including primary storage 606 (typically a random access memory, or RAM), and primary storage 604 (typically a read only memory, or ROM). As is well known in the art, primary storage 604 acts to transfer data and instructions uni-directionally to the CPU and primary storage 606 is used typically to transfer data and instructions in a bi-directional manner Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk that is slower than primary storage. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to a computer or telecommunications network using a network connection as shown generally at 612. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for dividing large disproportionate data sets may be stored on mass storage device 608 or 614 and executed on CPU 608 in conjunction with primary memory 606.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Systems are provided for manipulating large datasets for display, wherein a first dimension of the data to be displayed is much larger than a second dimension of the data to be displayed causing the dataset to be disproportional to a display on which the dataset is to be viewed. Such system may include a display and means for subdividing the dataset along the first dimension to form segments of the dataset, each segment having a fraction of the first dimension and all of the second dimension. Further provided are means for displaying at least a subset of the segments adjacent one another on the display, thereby using the area of the display more efficiently.

Means for displaying may be capable of displaying all of the segments on the display at the same time.

Means for receiving user input may be provided such that user input may serve as at least a partial basis for determining at least one of a number of the segments formed by the means for subdividing, and a size of at least one of the segments.

Means for receiving user input may be operated by a user to input information to select a number of the segments formed by the subdividing. Further means for user selection of a portion of the dataset along the second dimension to be displayed may be provided.

The system may further include means for calculating a centroid of data values within the selected portion along the second dimension, and means for displaying a centroid line through the calculated centroid value on the display.

The dataset may be a subset of a larger dataset, and the system may include means for user selection of the dataset from the larger dataset.

Means for receiving a selection by a user of a location on one of the displayed segments may be provided with the system.

Means for calculating and displaying a line through the center of the location and parallel to the first dimension to establish a reference line relative to the second dimension may be included, and means for calculating and displaying a line on each of the remaining displayed segments may be provided, such that the lines are displayed parallel to the first dimension and at the same location relative to the second dimension established with the generation of the line through the center of the selected location.

The system may be capable of receiving a selection of at least an additional location on one of the displayed segments, and repeating the calculating and displaying functions to display reference lines with regard to more than one selected location.

Means for inputting a reference to a location in at least one of the segments to establish a reference line relative to the second dimension may be provided.

Means for calculating and displaying a line through the center of the location and parallel to the first dimension to establish a reference line relative to the second dimension in each segment that is displayed may be provided.

Further, means for zooming the segments that are displayed may be provided, wherein the zooming is based upon a selected area within one of the displayed segments.

The means for zooming may zoom the selected area and corresponding areas in the other displayed segments along the second dimension, so that only the selected portion and corresponding areas are displayed in the second dimension is displayed while the entire first dimension of each segment is displayed.

Optionally, only a portion of the total number of segments may be displayed on the display at any one time, and the system may provide means for scrolling from one display image of displayed segments to another to view successive sets of segments.

The means for scrolling may further include a scale to provide the user with context as to where in the dataset the data shown in the present display is being viewed from.

Further, means for receiving selections by a user of less than all of the segments that are displayed on the display may be provided; and means for zooming and displaying the selected segments to maximize use of the display may be provided.

Means for subdividing segments selected by the user may be provided, and means for zooming and displaying the subdivided, selected segments may be provided by the system.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, hardware element, process, process step or steps, to the objective, spirit and scope of the present invention. All such modifications are intended to be within the scope of the claims appended hereto.

That which is claimed is:

1. A method of manipulating large datasets for display, wherein a first dimension of the data to be displayed is much larger than a second dimension of the data to be displayed causing the dataset to be disproportional to a display on which the dataset is to be viewed, said method comprising the steps of:
subdividing the dataset along the first dimension to form segments of the dataset, each segment having a fraction of the first dimension and all of the second dimension; and
displaying at least a subset of the segments adjacent one another on the display, thereby using the area of the display more efficiently.

2. The method of claim 1, wherein all of the segments are displayed on the display at the same time.

3. The method of claim 1, wherein said subdividing is performed automatically, based on the first and second dimensions and dimensions of the display on which the dataset is to be viewed.

4. The method of claim 1, wherein at least one of a number of said segments formed by said subdividing and a size of at least one of said segments is determined by user input.

5. The method of claim 1, wherein said segments have approximately equal dimensions.

6. The method of claim 1, further comprising the steps of:
selecting a location on one of the displayed segments;
displaying a line through the center of the location and parallel to the first dimension to establish a reference line relative to the second dimension; and
displaying a line on each of the remaining displayed segments, parallel to the first dimension and at the same location relative to the second dimension established with the generation of the line through the center of the selected location.

7. The method of claim 6, further comprising selecting another location on one of the displayed segments, and repeating the displaying steps of claim 6 to display reference lines with regard to more than one selected location.

8. The method of claim 1, further comprising the steps of:
providing means for user selection of a location to establish a reference line relative to the second dimension;
inputting a location to establish the reference line; and
displaying a line through the location and parallel to the first dimension to establish a reference line relative to the second dimension at the inputted location, on all displayed segments.

9. The method of claim 8, further comprising dragging and dropping one of the displayed reference lines to change the location thereof relative to the second dimension, wherein the remaining reference lines corresponding to the reference line having been dragged and dropped are automatically repositioned to the same respective location relative to the second dimension.

10. The method of claim 6, further comprising dragging and dropping one of the displayed lines to change the location thereof relative to the second dimension, wherein the remaining lines corresponding to the line having been dragged and dropped are automatically repositioned to the same respective location relative to the second dimension.

11. The method of claim 1, further comprising the steps of:
selecting an area within one of the displayed segments to be zoomed;
zooming the selected area to be zoomed, in the second dimension, so that only the selected portion of the segment in the second dimension is displayed while the entire first dimension of the segment is displayed; and
zooming corresponding areas of the remaining displayed segment in the second dimension, so that only the dimension of the corresponding area in each segment is displayed while the entire first dimension of each segment is displayed.

12. The method of claim 1, wherein only a portion of the total number of segments are displayed on the screen at any one time, said method further comprising:
providing means for scrolling from one screen of displayed segments to another; and
scrolling from the displayed screen of segments to another display of other segment not displayed on the displayed screen of segments which was scrolled from.

13. The method of claim 1, further comprising selecting less than all of the segments that are displayed; zooming the selected segments to maximize use of the display; and displaying only the zoomed, selected segments.

14. The method of claim 1, further comprising selecting less than all of the segments that are displayed, subdividing the selected segments, zooming the subdivided, selected segments and displaying the subdivided selected segments.

15. The method of claim 14, wherein a number of subdivided, selected segments is equal to a number of segments that were previously displayed prior to said selecting less than all of the segments.

16. The method of claim 1, wherein a number of said segments formed by said subdividing is selected by user input, and further wherein a selected portion of the dataset along the second dimension is displayed based upon user input.

17. The method of claim 16, further comprising calculating a centroid of data values within the selected portion along the second dimension, and displaying a centroid line through the calculated centroid value on the display.

18. The method of claim 16, wherein the dataset is a subset of a larger dataset selected through user input.

19. A method comprising forwarding a result obtained from the method of claim 1 to a remote location.

20. A method comprising transmitting data representing a result obtained from the method of claim 1 to a remote location.

21. A method comprising receiving a result obtained from a method of claim 1 from a remote location.

22. A system for manipulating large datasets for display, wherein a first dimension of the data to be displayed is much larger than a second dimension of the data to be displayed causing the dataset to be disproportional to a display on which the dataset is to be viewed, said system comprising:
a display;
means for subdividing the dataset along the first dimension to form segments of the dataset, each segment having a fraction of the first dimension and all of the second dimension; and
means for displaying at least a subset of the segments adjacent one another on said display, thereby using the area of the display more efficiently.

23. A computer readable medium carrying one or more sequences of instructions for manipulating large datasets for display, wherein a first dimension of the data to be displayed is much larger than a second dimension of the data to be displayed causing the dataset to be disproportional to a display on which the dataset is to be viewed, wherein execution of one or more sequences of instructions by one or more processors causes the one or more processors to perform the steps of:
subdividing the dataset along the first dimension to form segments of the dataset, each segment having a fraction of the first dimension and all of the second dimension; and
displaying at least a subset of the segments adjacent one another on the display, thereby using the area of the display more efficiently.
